(19) United States
(12) Patent Application Publication
(10) Pub. No.: US 2016/0357577 A1
(43) Pub. Date: Dec. 8, 2016

(54) METHOD AND DEVICE FOR DISPLAYING THE EXECUTION STATUS OF AN APPLICATION

(71) Applicant: LEAUTO INTELLIGENT TECHNOLOGY (BEIJING) CO.LTD, Beijing (CN)

(72) Inventors: Guowei GAO, Beijing (CN); Yang JIANG, Beijing (CN); Lulu ZHOU, Beijing (CN); Fei ZHAO, Beijing (CN)

(21) Appl. No.: 14/971,942

(22) Filed: Dec. 16, 2015

(30) Foreign Application Priority Data
Jun. 3, 2015 (CN) 201510301074.3

(51) Int. Cl. G06F 9/44; G10L 15/22; G06F 3/16; G06F 3/0481; G06F 3/0482

(52) U.S. Cl. CPC G06F 9/4446; G06F 3/04817; G06F 3/0482; G06F 3/167; G10L 15/22; G10L 2015/223

(57) ABSTRACT

The disclosure is related to a method and a device for displaying the execution status of an application. The method comprises receiving a non-touch instruction of the application; searching the application according to the instruction; and executing an operation with a specific display effect on the determined icon. The disclsoure further discloses a device for displaying the execution status of an application. The disclosure displays the non-touch instructions for the applications sent from users such that the user may understand the execution status sufficiently of the applications during usage.

### CROSS REFERENCE TO RELATED APPLICATION

This application claims priority under 35 U.S.C. §119(a) to Patent Application No(s). 201510301074.3, filed in China on Jun. 3, 2015, the entire contents of which are hereby incorporated by reference.

### FIELD OF TECHNOLOGY

The disclosure is related to computer technology field, and more particular to a method and a device for displaying the execution status of an application.

### BACKGROUND

Currently, one class of instructions among the instructions for controlling the on-board computers is input to the on-board computers through the specific devices. Those instructions are referred as non-touch instructions. The specific devices for inputting the non-touch instructions generally do not over distract drivers to input the instructions, such as microphone, or the button instructions input from the physical buttons integrated on the multi-function steering wheel or other positions in the car, etc.

The users input the non-touch instructions to the on-board computers to trigger the on-board computers to trigger applications or close applications.

The icon window bar in the left portion of the screen of the on-board computer displays the icons mapped with the applications such as “TELEPHONE” application, and the application window bar in the right portion of the screen displays the interface of the “TELEPHONE” application. Taking that the user inputs a non-touch instruction to the on-board computer to trigger the on-board computer to execute the video and audio application as an example, the specific steps of the process includes:

the on-board computer receives the non-touch instruction;

the on-board computer obtains the information for indicating the video and audio application according to the non-touch instruction and receives the operation information “open”.

The on-board computer executes the video applications according to the above two information. Furthermore, the on-board computer displays the video application interface in the application window bar at the right portion of the screen, and still displays the “telephone” icon in accordance with the high brightness display effect in the application window bar at the left portion of the screen.

Apparently, according to the above prior art, it is likely that the user may not clearly know the execution status of the telephone application and the video application such that the user may misuse the application and the processing resources of the on-board computer is wasted.

### SUMMARY

The embodiments of the disclosure provide a method and a device for displaying the execution status of an application. In order to solve the problem existing in the current technology, a solution is provided to display the execution status of an application after the non-touch instruction is received.

The embodiment of the disclosure provides a method for displaying the execution status of an application, comprising: receiving a non-touch instruction of the application; searching the application according to the instruction; and executing an operation with a specific display effect on the determined icon.

The embodiment of the disclosure provides a device for displaying the execution status of an application, comprising: a receiving unit for receiving a non-touch instruction of the application; a searching unit for searching the application according to the instruction; a determining unit for determining an icon in an icon window bar mapped with the searched application according to the default mapping relationship between the application and the icon in the icon window bar; and a display unit for executing an operation with a specific display effect on the determined icon.

The embodiment of the disclosure provides a device for displaying the execution status of an application, comprising: a processor; a memory for storing one or more instructions; wherein when the one or more instructions are executed by the processor, the processor executes the following steps: receiving a non-touch instruction of the application; searching the application according to the instruction; determining an icon in an icon window bar mapped with the searched application according to the default mapping relationship between the application and the icon in the icon window bar; and executing an operation with a specific display effect on the determined icon.

At least one technical solution adopted by the embodiment of the disclosure may achieve the following advantageous effects. The application is searched through receiving a non-touch instruction of the application first, and then the determined icon is displayed by a specific display effect according to the default mapping relationship between the application and the icon in the icon window bar. This is to display the non-touch instruction sent for the application such that the user may understand the execution status of the applications during usage.

### BRIEF DESCRIPTION OF THE DRAWINGS

In order to illustrate the technical schemes of the prior art or the embodiments of the disclosure more clearly, the accompanying drawings for illustrating the prior art or the embodiments of the disclosure are briefly described as below. It is apparent that the drawings described below are merely some embodiments of the disclosure, and those skilled in the art may derive other drawings according the drawings described below without creative endeavor. In the drawings:

FIG. 1 illustrates the display interface of the on-board computer;

FIG. 2 illustrates the display interface of the on-board computer;

FIG. 3 schematically illustrates the specific flow chart for the method for displaying the execution status of the application according to the first embodiment of the disclsoure;

FIG. 4 schematically illustrates the specific block diagram for the device for displaying the execution status of the application according to the second embodiment of the disclosure;

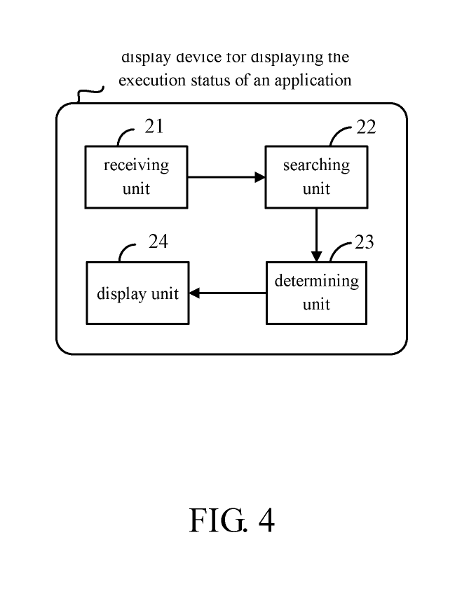

FIG. 5-1 schematically illustrates the specific flow chart for the method for displaying the opening status of the application of the on-board computer according to the third embodiment of the disclosure;

FIG. 5-2 illustrates the interface of the on-board computer according to the third embodiment of the disclosure;

FIG. 6-1 schematically illustrates the specific flow chart for the method for displaying the closing status of the application of the on-board computer according to the fourth embodiment of the disclosure;

FIG. 6-2 illustrates the interface of the on-board computer according to the fourth embodiment of the disclosure; and

FIG. 7 schematically illustrates the specific block diagram for the device for displaying the execution status of the application according to the fifth embodiment of the disclosure.

### DESCRIPTION OF THE EMBODIMENTS

For the purpose, technical solution, and advantage of the disclosure becoming clearer, the specific embodiments of the disclosure combined with the accompanying drawings to clearly and completely are described as follows. Obviously, the described embodiments are only part of the embodiments of the disclosure rather than all embodiments. Based on the embodiments of the disclosure all other embodiments obtained by those having ordinary skills in this field without creative work are within the scope of protection of the disclosure.

After practicing, the inventors discover that during driving, it is not proper for the drivers to send too many touch instructions for the touch screen. Otherwise it will distract the driver and endanger their personal safety. With the development of the car industry, the steering wheels or the shifts of vehicles are equipped with physical buttons such that the non-touch instructions of voices or physical buttons may be used while drivers concentrate on the traffic. It distracts the driver as little as possible to control the on-board computer for ensuring driving safety. However the inventors further discovers that the on-board computers indeed execute the non-touch instructions after receiving the non-touch instruction. However the screen of the on-board computer does not properly display the execution status of the applications such that a definite indication cannot be sent to the driver. The driver may probably touch the touch screen again to send touch instruction, and thus the error operation may occur (such as closing the application that has been opened). It is not conducive to driving safety. Therefore the disclosure is provided based on these deficiencies.

### First Embodiment

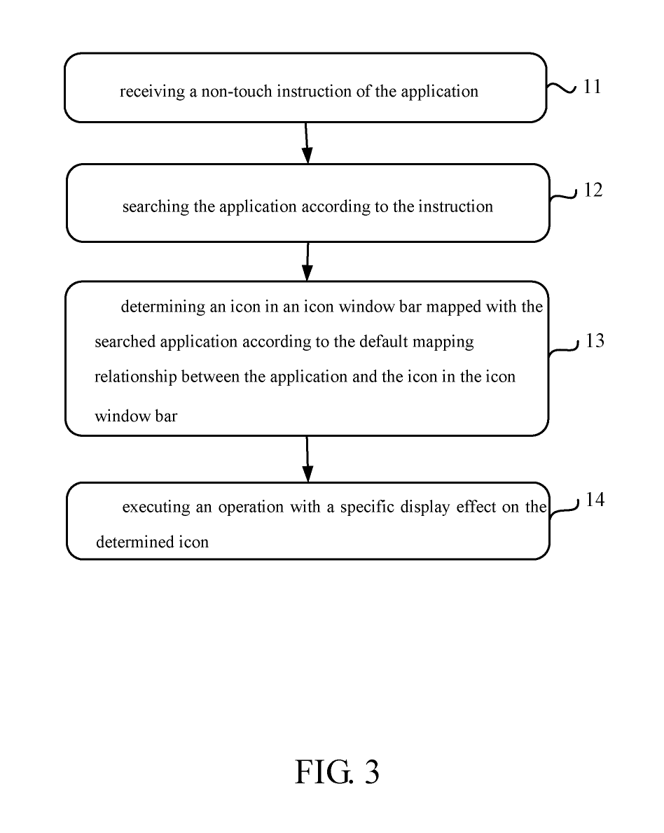

First Embodiment provides a method for displaying the execution status of an application. In order to solve the problem existing in the current technology, a solution is provided to display the execution status of an application after the non-touch instruction is received. The specific flow of the method is illustrated in FIG. 3, comprising the following step:

Step 11: receiving a non-touch instruction of an application.

The execution body may be an on-board computer, which is a dedicated automotive information product integrated with automotive electronics. It is an automotive multimedia information center with high integration. The on-board computer may achieve all the functions of the personal computer, such as car Internet access, audio and video entertainment, satellite positioning, navigation, games, telephone, fault detection, etc. In addition, it can also be an intelligent terminal.

With regard to Step 11, the step of receiving a non-touch instruction of an application may include, but does not limit to, as least one of the following:

receiving a voice instruction for the application,

receiving a button instruction for the application, and

receiving an internal trigger instruction for the application.

Specifically, an audio receiver such as a microphone may be used to receive a voice instruction sent for the application, like “OPEN TELEPHONE”, or “I WANT TO CALL”. The button instruction may be the instructions sent from the physical buttons configured on the car steering wheels or car shifts, or may be the physical buttons on the intelligent terminals. For example, the car steering wheels may be configured with physical function buttons such as “TELEPHONE”, “NAVIGATION”, or “MUSIC”. Alternatively, the car shifts may be configured with physical function buttons such as “NAVIGATION” or “CAR CONDITION”. Yet alternatively, the intelligent terminals may be configured with physical function buttons such as “TELEPHONE” or “MUSIC”. Because the on-board computer or the intelligent terminal executes the intelligent system, trigger instructions may be sent for applications by the system internally under certain circumstances. For example, when the intelligent system of the on-board computer monitors the tire pressure problems, or the volume of the fuel tank below the safety threshold, the system sends an open instruction for “CAR CONDITION” application to open the “CAR CONDITION” application. Then the application alerts the user based on the current security issues.

In practical applications, the non-touch instructions may open or close the applications. Therefore, for Step 11, the step of receiving a non-touch instruction of the application may further includes:

receiving a non-touch instruction for opening an application; or

receiving a non-touch instruction for closing an application.

Specifically, for example, the on-board computer may receive an audio instruction “OPEN TELEPHONE” from the driver or the passenger for opening the car telephone, or may be an audio instruction “CLOSE TELEPHONE” for closing the car telephone. Alternatively, the on-board computer may receive a signal click physical button instruction of “NAVIGATION” function from the driver or the passenger for opening the navigation application, or may also receive a double click physical button instruction of “NAVIGATION” function from the driver or the passenger for closing the navigation application. When the specific function unit of the intelligent system of the on-board computer monitors that the volume of oil is below the safety threshold, the function unit may send an internal trigger instruction for opening the “CAR CONDITION” application. When the function unit monitors that the volume of oil is higher than the safety threshold, the function unit may send an internal trigger instruction for closing the “CAR CONDITION” application.

Step 12: searching the application according to the instruction.

For Step 12, when receiving the non-touch instruction for the application, the on-board computer searches the application according to the instruction. For example, when the on-board computer receives the signal click physical button instruction of “NAVIGATION” function from the driver or the passenger for opening the navigation application, or receives the double click physical button instruction of “NAVIGATION” function from the driver or the passenger for closing the navigation application, the on-board computer needs to search the “NAVIGATION” application corresponding to the instruction. Similarly, when the on-board computer receives the internal trigger instruction for opening the “CAR CONDITION” application, or receives the internal trigger instruction for closing the “CAR CONDITION” application, the on-board computer searches the “CAR CONDITION” application corresponding to the instruction.

When the on-board receives the voice instruction “OPEN TELEPHONE” from the driver or the passenger for opening the car telephone, or receives the voice instruction “CLOSE TELEPHONE” for closing the car telephone, the on-board computer needs to search the “TELEPHONE” application corresponding to the instruction. However, in this embodiment, the voice recognition technology is required for implementation.

Therefore, when the on-board computer receives the voice instruction for the application, the step of determining the application according to the instruction may include performing voice recognition for the voice instruction, and searching the application according to the result of the voice recognition. For example, when the on-board computer receives the voice instruction “I WANT TO CALL”, the on-board computer performs voice recognition for “I WANT TO CALL”, and searches the “TELEPHONE” application corresponding to the instruction.

In the description of Step 11, the step of receiving the non-touch instruction for the application may include receiving the non-touch instruction for opening the application and receiving the non-touch instruction for closing the application.

Therefore, for the non-touch instructions of these two different types (open and close), Step 12 also has two execution manners.

First Execution Manner:

When the received non-touch instruction for the application is the non-touch instruction for opening the instruction, the step of searching the application according to the instruction may include searching the application to be opened according to the non-touch instruction for opening the application.

For example, when the on-board computer receives the signal click physical button instruction of “NAVIGATION” function from the driver or the passenger for opening the navigation application, the on-board computer searches the “NAVIGATION” application to be opened. For another example, when the on-board computer receives the voice instruction “OPEN TELEPHONE” from the driver or the passenger for opening the car telephone, the on-board computer performs voice recognition for the voice instruction and then searches the “TELEPHONE” application to be opened.

Second Execution Manner:

When the received non-touch instruction for the application is the non-touch instruction for closing the instruction, the step of searching the application according to the instruction may include searching the application to be closed according to the instruction and determining the application to be executed.

Specifically, since the onboard computer or the intelligent terminal is capable of multi-tasking, after the application to be closed is searched, the application to be executed may also appear. For example, when the on-board computer is executing the “NAVIGATION” application, the “TELEPHONE” application exists in the background. If the “NAVIGATION” application is closed, the “TELEPHONE” application in the background will be executed in the foreground. When the on-board computer receives the double click physical button instruction of “NAVIGATION” function from the driver or the passenger for closing the navigation application, the on-board computer searches the “NAVIGATION” application to be closed. As the “TELEPHONE” application is executing in the background, when the “NAVIGATION” application is closed, the “TELEPHONE” application will be executed in the foreground. Therefore, the “NAVIGATION” application to be closed in searched according to the instruction, and the “TELEPHONE” application to be executed is determined.

In another embodiment, it may further include closing the searched application to be closed, and determining the application currently executed.

Specifically, according to the instruction, the on-board computer closes the searched application to be closed, and then determines the application currently executed. For example, also taking the example that the on-board computer is executing the “NAVIGATION” application, and the “TELEPHONE” application appears in the background” as an example, when the on-board computer receives the double click physical button instruction of “NAVIGATION” function from the driver or the passenger for closing the navigation application, after the on-board computer closes the “NAVIGATION” application according to the instruction, the “TELEPHONE” application will be the application to be executed in the foreground. Therefore, the “TELEPHONE” application is determined as the application currently executed.

Step 13: determining an icon in an icon window bar mapped with the searched application according to the default mapping relationship between the application and the icon in the icon window bar.

For Step 13, the default mapping relationship exists between the application and the icon in the icon window bar. For example, the default mapping relationship exists between the “TELEPHONE” application and the “TELEPHONE” icon.

Because the on-board computer or the intelligent terminal has various applications, for some GUI designs, each of a few common applications (such as navigation, audio, telephone, care condition, etc.) has a unique icon, each application having a mapping relationship with the icon. However, for some less common applications (such as system updates, file management, etc.), the mapping relationship exists between multiple applications and an icon. Therefore, in one embodiment, the icon window bar includes at least the following two types of icons: an exclusive icon for a single application and a sharing icon for at least two applications. The exclusive icon for a single application indicates that the unique default mapping relationship exists between an application and the exclusive icon. For example, the “TELEPHONE” application exclusively uses the “TELEPHONE” icon. The sharing icon for at least two applications indicates that the default mapping relationship exists between one of the at least two applications and the sharing icon. For example, the applications such as “SYSTEM UPDATES”, “FILE MANAGEMENT”, and “SET UP” share the “MORE APPLICATIONS” icon.

According to the default mapping relationship, the on-board computer determines an icon in an icon window bar mapped with the application searched in Step 12. For example, the “TELEPHONE” application is searched in Step 12. Then the “TELEPHONE” icon in the icon window bar is determined according to the default mapping relationship existing between the “TELEPHONE” application and the “TELEPHONE” icon.

In Step 12, for the non-touch instructions of these two different types (open and close), the application to be opened or the application to be closed is searched. According to the default mapping relationship between the application and the icon in the icon window bar, Step 13 may determine the icon in the icon window bar mapped with the searched application to be opened, or determine the icon in the icon window bar mapped with the searched application to be closed.

In the description of Step 12, since the on-board computer or the intelligent terminal is capable of multi-tasking, after the searched application to be closed is closed, other applications will be determined as the applications currently executed.

Therefore, in one embodiment, after closing the searched application to be closed and determining the application currently executed, the step of determining an icon in an icon window bar mapped with the searched application according to the default mapping relationship between the application and the icon in the icon window bar may include a step of determining a first icon in icon window bar mapped with the application to be closed according to the default mapping relationship between the application and the icon in the icon window bar and a second icon in icon window bar mapped with the application currently executed.

For example, also taking the example that the on-board computer is executing the “NAVIGATION” application, and the “TELEPHONE” application appears in the background” as an example, when the on-board computer receives the double click physical button instruction of “NAVIGATION” function from the driver or the passenger for closing the navigation application, after the on-board computer closes the “NAVIGATION” application, the “TELEPHONE” application is determined as the application currently executed. According to the default mapping relationship between the application and the icon in the icon window bar, the “NAVIGATION icon is determined as the first icon and the “TELEPHONE” icon is determined as the second icon.

Step 14: executing an operation with a specific display effect on the determined icon.

In Step 11, it is illustrated that receiving the non-touch instruction for the application may include the non-touch instruction for opening the application and the non-touch instruction for closing the application. Therefore, Step 12 has two execution manners. However, the manners for determining the icon in Step 13 according to the two execution manners in Step 12 are the same. Therefore, for Step 14, there are two execution manners for the determined applications.

First Execution Manner:

For the first execution manner in Step 12, the step of searching the application according to the instruction may include the step of searching the application to be opened according to the instruction for opening the application.

The step of executing an operation with a specific display effect on the determined icon may include a step of executing an operation with a specific display effect on the determined icon in the icon window bar, determined in Step 13, mapped with the application to be opened.

Specifically, after searching out the application to be opened, and determining the icon in the window icon bar mapped with the searched application to be opened according to the default mapping relationship between the application and the icon in the icon window bar, it may add the specified display effect on the determined icon in order to display the status of an application to be opened. For example, after the “TELEPHONE” application to be opened is searched out, and the “TELEPHONE” icon is determined according to the default mapping relationship between the application and the icon in the icon window bar, the “TELEPHONE” icon may be added with the display effect of the high brightness in order to display the “TELEPHONE” application to be opened.

Second Execution Manner:

When the step of searching the application according to the instruction includes the step of searching the application to be closed and determining the application currently executed such that Step 13 includes determining a first icon in icon window bar mapped with the application to be closed and a second icon in icon window bar mapped with the application currently executed according to the default mapping relationship between the application and the icon in the icon window bar.

The step of executing an operation with a specific display effect on the determined icon may include a step of executing an operation with a first specified display effect on the icon corresponding to the instruction to be closed and executing an operation with a second specified display effect on the icon corresponding to the instruction currently executed when the first icon and the second icon are an exclusive icon, or the first icon is an exclusive icon and the second is a sharing icon, or the first icon is a sharing icon and the second is an exclusive icon, or the first icon and the second icon are different sharing icon, or may include executing an operation with a second specified display effect on the icon corresponding to the instruction to be closed when the first icon and the second icon are the same sharing icon.

For example, when the first icon and the second icon are an exclusive icon, the firs icon may be the “NAVIGATION” icon, and the second icon may be the “TELEPHONE” icon.

Alternatively, when the first icon is an exclusive icon and the second is a sharing icon, the firs icon may be the “NAVIGATION” icon, and the second icon may be the “MORE APPLICATION” icon.

Or when the first icon is a sharing icon and the second is an exclusive icon, the firs icon may be the “MORE APPLICATIONS” icon, and the second icon may be the “NAVIGATION” icon.

Then an operation with the original display effect is executed on the first icon, and an operation with the high brightness effect is executed on the second icon.

When the first icon and the second icon are the same sharing icon, the first icon and the second icon are the “MORE APPLICATIONS” icon, an operation with the high brightness effect is executed on the first icon (the second icon).

In in the method of the first embodiment, the application is searched through receiving a non-touch instruction of the application first, and then the determined icon is displayed by a specific display effect according to the default mapping relationship between the application and the icon in the icon window bar. This is to display the non-touch instruction sent for the application such that the user may understand the execution status of the applications during usage.

It should be noted that each step of the method of the first embodiment may be executed by the same apparatus, or each step of the method may be executed by different apparatuses. For example, Step 11 and Step 12 may be executed by a first apparatus, and Step 13 and Step 14 may be executed by a second apparatus. Or Step 11 may be executed by the first apparatus, and Step 12, Step 13, and Step 14 may be executed by the second apparatus.

### Second Embodiment

Based on the same invention concept, the second embodiment provides a device for displaying the execution status of an application. In order to solve the problem existing in the current technology, a solution is provided to display the execution status of an application after the non-touch instruction is received. As illustrated in FIG. 3, the device includes:

a receiving unit 21 for receiving a non-touch instruction of the application;

a searching unit 22 for searching the application according to the instruction;

a determining unit 23 for determining an icon in an icon window bar mapped with the searched application according to the default mapping relationship between the application and the icon in the icon window bar; and

a display unit 24 for executing an operation with a specific display effect on the determined icon.

In one embodiment, the receiving unit 21 may be used to execute at least one of the following operations: receiving a voice instruction for the application, receiving a button instruction for the application, and receiving an internal trigger instruction for the application.

In one embodiment, when the receiving unit 21 is used for receiving the voice instruction for the application, the searching unit 22 may be used for performing voice recognition for the voice instruction, and searching the application according to the result of the voice recognition.

In one embodiment, the receiving unit 21 may be used for receiving the non-touch instruction for opening the application and receiving the non-touch instruction for closing the application.

In one embodiment, the icon window bar includes at least the following two types of icons: an exclusive icon for a single application and a sharing icon for at least two applications.

In one embodiment, the searching unit 22 is used for searching the application to be closed and determining the application to be executed according to the instruction when the non-touch instruction for the application received by the receiving unit is a non-touch instruction for closing the application.

The searching unit 22 is further used for closing the searched application to be closed and determining the application currently executed.

In one embodiment, after closing the searched application to be closed and determining the application currently executed, the determining unit 23 may be used for determining a first icon in icon window bar mapped with the application to be closed and a second icon in the icon window bar mapped with the application currently executed according to the default mapping relationship between the application and the icon in the icon window bar.

The display unit 24 may be used for executing an operation with a first specified display effect on the icon corresponding to the instruction to be closed and executing an operation with a second specified display effect on the icon corresponding to the instruction currently executed when the first icon and the second icon are an exclusive icon, or the first icon is an exclusive icon and the second is a sharing icon, or the first icon is a sharing icon and the second is an exclusive icon, or the first icon and the second icon are different sharing icon, or may include executing an operation with a second specified display effect on the icon corresponding to the instruction to be closed when the first icon and the second icon are the same sharing icon.

In in the device of the second embodiment, the application is searched through receiving a non-touch instruction of the application first, and then the determined icon is displayed by a specific display effect according to the default mapping relationship between the application and the icon in the icon window bar. This is to display the non-touch instruction sent for the application such that the user may understand the execution status of the applications during usage.

In the embodiment of the disclosure, the relevant functional modules may be implemented by using the hardware processor.

The apparatus embodiments described above are merely illustrative, wherein the unit described as a separate member may or may not be physically separate, and as part of the display unit may or may not be physical units, i.e., it may be located in one place, or may be distributed to various network elements. Some or all of the modules may be selected to achieve the purpose of the present examples of the embodiments according to the actual need. Those of ordinary skill in the case may understand and implement the disclosure without paying any creative work.

### Third Embodiment

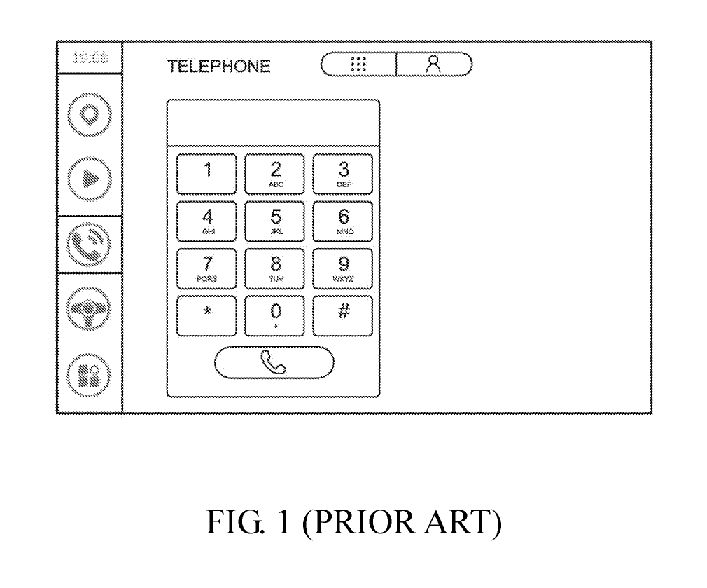

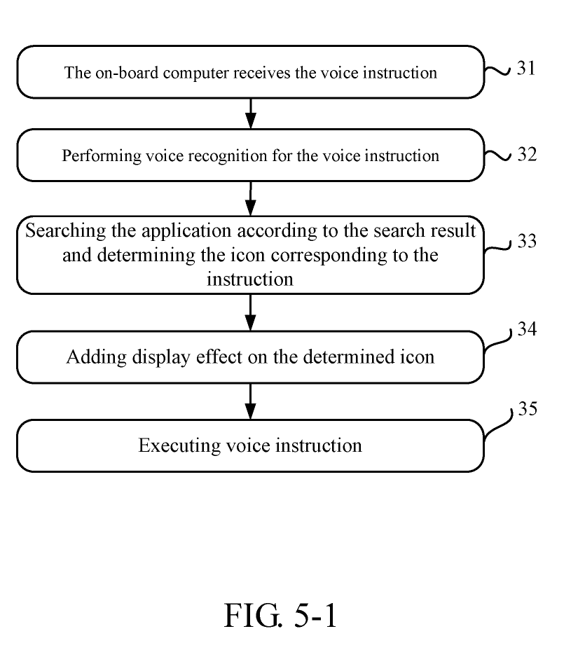

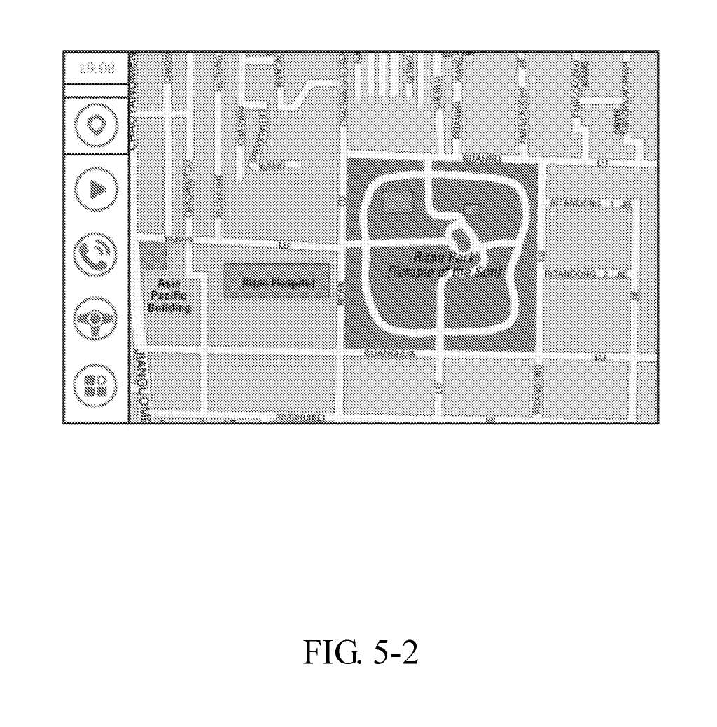

Based on the same invention concept, the third embodiment provides a method for displaying the execution status of an application. A solution is provided to display the execution status of an application after the non-touch instruction is received. As illustrated in FIG. 5-1, the method includes the following steps:

Step 31: the on-board computer receives the voice instruction “OPEN THE MAP”.

Step 32: performing voice recognition for “OPEN THE MAP”.

Step 33: when the recognition result is open “NAVIGATION” application, the “NAVIGATION” application is searched out and the “NAVIGATION” icon is determined according to the mapping relationship between the application and the icon in the icon window bar.

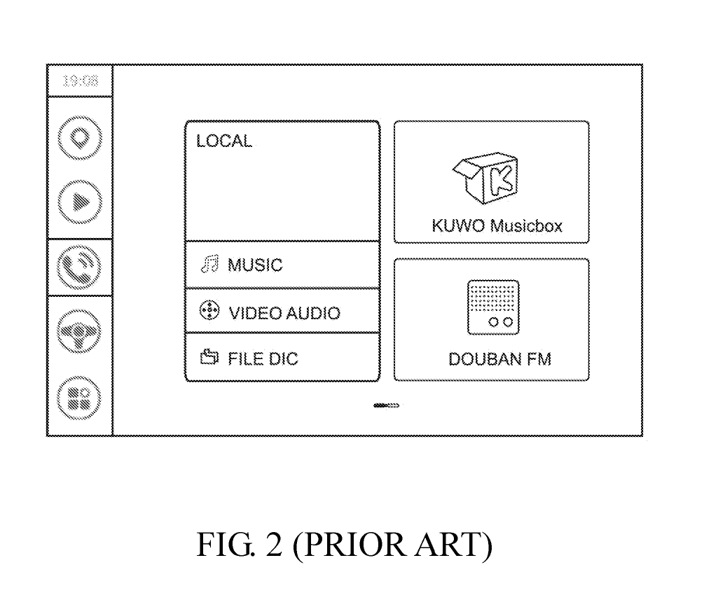

Step 34: as shown in FIG. 5-2, the “NAVIGATION” icon is displayed with gray display effect in the icon window bar.

Step 35: open “NAVIGATION” application.

In the method of the third embodiment, the application is searched through receiving a non-touch instruction of the application first, and then the determined icon is displayed by a specific display effect according to the default mapping relationship between the application and the icon in the icon window bar. This is to display the non-touch instruction sent for the application for the driver such that the user may understand the execution status of the applications during driving.

### Fourth Embodiment

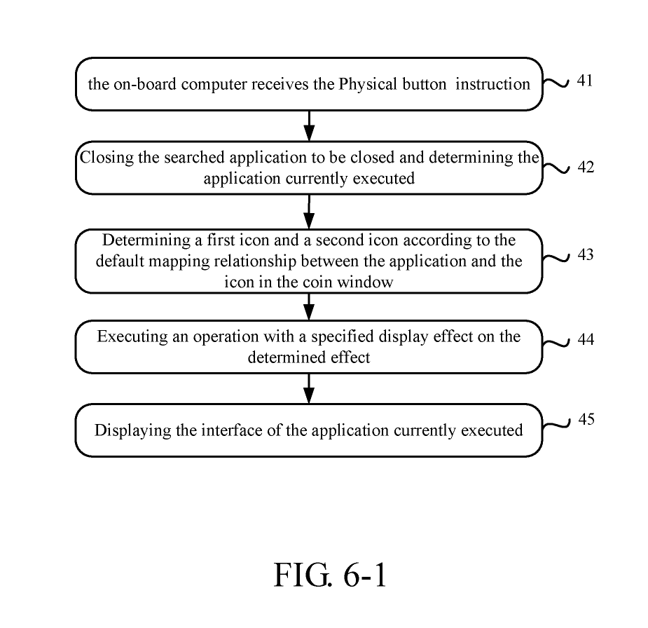

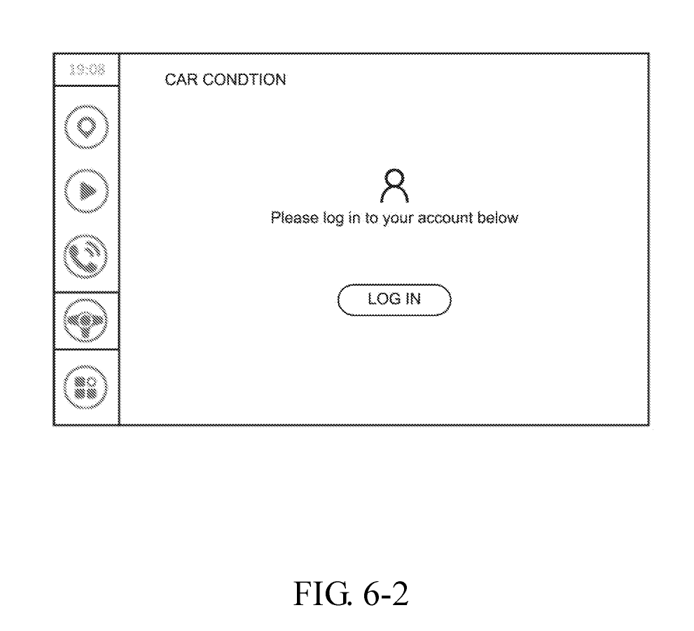

Based on the same invention concept, the fourth embodiment provides a method for displaying the closing status of an application. A solution is provided to display the execution status of an application after the non-touch instruction is received. As illustrated in FIG. 6-1, the method includes the following steps:

Step 41: the on-board computer receives the instruction for closing the “NAVIGATON” application through the multi-function steering wheel by the driver.

Step 42: closing the searched “NAVIGATION” application and determining the “CAR CONDITION” application as the application currently executed.

Step 43: determining the “NAVIGATION” icon is the first icon and the “CAR CONDITION” icon is the second icon according to the default mapping relationship between the application and the icon in the icon window bar.

Step 44: because the first icon and the second icon are the exclusive icons, as shown in FIG. 6-2, the “NAVIGATION” icon is displayed by the origin display effect in the icon window bar, and the “CAR CONDITION” icon is display by gray effect.

Step 45: display the application interface of the car condition application in the application window bar at the right portion of the screen.

In the method of the fourth embodiment, the on-board computer receives the physical button instruction for the application and determines the application accordingly, and then executes an operation with a specified display effect on the determined application. In addition, the on-board computer makes the applications in the foreground and the background have different display effects. This is to display the execution status of the application for the driver such that the user may understand the execution status of the applications in the on-board computer during driving.

### Fifth Embodiment

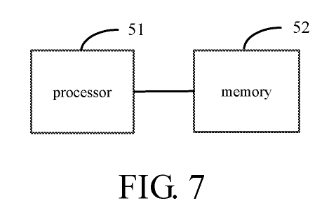

FIG. 7 schematically illustrates the specific block diagram for the device for displaying the execution status of the application according to the fifth embodiment of the disclosure. Based on the same invention concept, the fifth embodiment provides a device for displaying the execution status of an application. In order to solve the problem existing in the current technology, a solution is provided to display the execution status of an application after the non-touch instruction is received. As illustrated in FIG. 7, the device includes a processor 51 and a memory 52 for storing one or more instructions.

When the one or more instructions are executed by the processor, the processor executes the following steps:

receiving a non-touch instruction of the application;

searching the application according to the instruction;

determining an icon in an icon window bar mapped with the searched application according to the default mapping relationship between the application and the icon in the icon window bar; and

executing an operation with a specific display effect on the determined icon.

In one embodiment, when the step of receiving a non-touch instruction of the application comprises at least one of receiving a voice instruction for the application, receiving a button instruction for the application, and receiving an internal trigger instruction for the application.

In one embodiment, when receiving the voice instruction for the application, in the step of searching the application according to the instruction, the processor 51 further executes the following step:

performing voice recognition for the voice instruction; and

searching the application according to the result of the voice recognition.

In one embodiment, the icon window bar comprises at least the following two types of icons: an exclusive icon used by a signal application and a sharing icon shared by at least two applications.

In one embodiment, when receiving a non-touch instruction of the application is a non-touch instruction to close the application, in the step of searching the application according to the instruction, the processor 51 further executes the following step:

searching the applications to be closed according to the instruction and determining the application to be executed;

the method further comprises:

closing the searched application to be closed and determining the application currently executed.

In one embodiment, in the step of determining an icon in an icon window bar mapped with the searched application according to the default mapping relationship between the application and the icon in the icon window bar, and the step of executing an operation such that the determined icon is displayed by a specific display effect, the processor 51 further executes the following steps:

after closing the searched application to be closed and determining the application currently executed;

determining a first icon in icon window bar mapped with the application to be closed and a second icon in the icon window bar mapped with the application currently executed according to the default mapping relationship between the application and the icon in the icon window bar;

when the first icon and the second icon are an exclusive icon, or the first icon is an exclusive icon and the second is a sharing icon, or the first icon is a sharing icon and the second is an exclusive icon, or the first icon and the second icon are different sharing icon,

executing an operation with a first specified display effect on the icon corresponding to the instruction to be closed and executing an operation with a second specified display effect on the icon corresponding to the instruction currently executed;

when the first icon and the second icon are the same sharing icon, executing an operation with a second specified display effect on the icon corresponding to the instruction to be closed.

The above description of embodiments, those skilled in the art can clearly understand the various embodiments may be implemented by software plus a necessary universal hardware platform for implementation, and of course, also be implemented by hardware. Based on this understanding, the nature of the technical proposal or the part contributing to the prior art may be embodied in the form of a software product. The computer software product may be stored in a computer readable storage medium, such as ROM/RAM, magnetic disc, CD-ROM, including several instructions to instruct a computer device (a personal computer, a server, or a network equipment) to perform the method described in some parts of the various embodiments or examples.

Finally, it should be noted that the above embodiments are merely provided for describing the technical solutions of the disclosure, but not intended to limit the disclosure. Although reference to the embodiments of the disclosure has been described in details, those skilled in the art will appreciate that the technical solutions described in the foregoing embodiments can be modified, or equivalently replaced for some technical features; and such modifications or replacements do not make the essence of the corresponding technical solutions depart from the spirit and scope of the technical implementation of the disclosure.

What is claimed is:

1. A method for displaying the execution status of an application, comprising:
receiving a non-touch instruction of the application;
searching the application according to the instruction;
determining an icon in an icon window bar mapped with the searched application according to the default mapping relationship between the application and the icon in the icon window bar; and
executing an operation with a specific display effect on the determined icon.

2. The method according to claim 1, wherein the step of receiving a non-touch instruction of the application comprises at least one of receiving a voice instruction for the application, receiving a button instruction for the application, and receiving an internal trigger instruction for the application.

3. The method according to claim 1, wherein when receiving the voice instruction for the application, the step of searching the application according to the instruction comprises:
performing voice recognition for the voice instruction; and
searching the application according to the result of the voice recognition.

4. The method according to claim 1, wherein the icon window bar comprises at least the following two types of icons: an exclusive icon used by a signal application and a sharing icon shared by at least two applications.

5. The method according to claim 1, wherein when receiving a non-touch instruction of the application is a non-touch instruction to close the application, the step of searching the application according to the instruction comprises:
searching the applications to be closed according to the instruction and determining the application to be executed;
the method further comprises:
closing the searched application to be closed and determining the application currently executed.

6. The method according to claim 1, wherein the step of determining an icon in an icon window bar mapped with the searched application according to the default mapping relationship between the application and the icon in the icon window bar, and the step of executing an operation such that the determined icon is displayed by a specific display effect comprises:
after closing the searched application to be closed and determining the application currently executed;
determining a first icon in icon window bar mapped with the application to be closed and a second icon in the icon window bar mapped with the application currently executed according to the default mapping relationship between the application and the icon in the icon window bar;
when the first icon and the second icon are an exclusive icon, or the first icon is an exclusive icon and the second is a sharing icon, or the first icon is a sharing icon and the second is an exclusive icon, or the first icon and the second icon are different sharing icon,
executing an operation with a first specified display effect on the icon corresponding to the instruction to be closed and executing an operation with a second specified display effect on the icon corresponding to the instruction currently executed;
when the first icon and the second icon are the same sharing icon, executing an operation with a second specified display effect on the icon corresponding to the instruction to be closed.

7. A display device for displaying the execution status of an application, comprising:
a receiving unit for receiving a non-touch instruction of the application;
a searching unit for searching the application according to the instruction;
a determining unit for determining an icon in an icon window bar mapped with the searched application according to the default mapping relationship between the application and the icon in the icon window bar; and
a display unit for executing an operation with a specific display effect on the determined icon.

8. The device according to claim 7, wherein the icon window bar comprises at least the following two types of icons: an exclusive icon used by a signal application and a sharing icon shared by at least two applications.

9. The device according to claim 8, wherein when the non-touch instruction of the application received by the receiving unit is a non-touch instruction to close the application, the searching unit is used for searching the applications to be closed according to the instruction and determining the application to be executed;
the searching unit is further used for closing the searched application to be closed and determining the application currently executed.

10. The device according to claim 8, wherein after closing the searched application to be closed and determining the application currently executed the determining unit determines a first icon in icon window bar mapped with the application to be closed and a second icon in icon window bar mapped with the application currently executed according to the default mapping relationship between the application and the icon in the icon window bar;
when the first icon and the second icon are an exclusive icon, or the first icon is an exclusive icon and the second is a sharing icon, or the first icon is a sharing icon and the second is an exclusive icon, or the first icon and the second icon are different sharing icon,
the display unit executes an operation with a first specified display effect on the icon corresponding to the instruction to be closed and executes an operation with a second specified display effect on the icon corresponding to the instruction currently executed.

11. A device for displaying the execution status of an application, comprising:
a processor;
a memory for storing one or more instructions;
wherein when the one or more instructions are executed by the processor, the processor executes the following steps:
receiving a non-touch instruction of the application;
searching the application according to the instruction;
determining an icon in an icon window bar mapped with the searched application according to the default mapping relationship between the application and the icon in the icon window bar; and
executing an operation with a specific display effect on the determined icon.

12. The device according to claim 11, wherein when the step of receiving a non-touch instruction of the application comprises at least one of receiving a voice instruction for the application, receiving a button instruction for the application, and receiving an internal trigger instruction for the application.

13. The device according to claim 11, wherein when receiving the voice instruction for the application, in the step of searching the application according to the instruction, the processor further executes the following step:
performing voice recognition for the voice instruction; and
searching the application according to the result of the voice recognition.

14. The device according to claim 11, wherein the icon window bar comprises at least the following two types of icons: an exclusive icon used by a signal application and a sharing icon shared by at least two applications.

15. The device according to claim 11, wherein when receiving a non-touch instruction of the application is a non-touch instruction to close the application, in the step of searching the application according to the instruction, the processor further executes the following step:
searching the applications to be closed according to the instruction and determining the application to be executed;
the method further comprises:
closing the searched application to be closed and determining the application currently executed.

16. The device according to claim 11, wherein in the step of determining an icon in an icon window bar mapped with the searched application according to the default mapping relationship between the application and the icon in the icon window bar, and the step of executing an operation such that the determined icon is displayed by a specific display effect, the processor further executes the following steps:
after closing the searched application to be closed and determining the application currently executed;
determining a first icon in icon window bar mapped with the application to be closed and a second icon in the icon window bar mapped with the application currently executed according to the default mapping relationship between the application and the icon in the icon window bar;
when the first icon and the second icon are an exclusive icon, or the first icon is an exclusive icon and the second is a sharing icon, or the first icon is a sharing icon and the second is an exclusive icon, or the first icon and the second icon are different sharing icon,
executing an operation with a first specified display effect on the icon corresponding to the instruction to be closed and executing an operation with a second specified display effect on the icon corresponding to the instruction currently executed;
when the first icon and the second icon are the same sharing icon, executing an operation with a second specified display effect on the icon corresponding to the instruction to be closed.
